(19) United States
(12) Patent Application Publication
(10) Pub. No.: US 2018/0253894 A1
(43) Pub. Date: Sep. 6, 2018

(54) HYBRID FOREGROUND-BACKGROUND TECHNIQUE FOR 3D MODEL RECONSTRUCTION OF DYNAMIC SCENES

(71) Applicant: INTEL CORPORATION, Santa Clara, CA (US)

(72) Inventors: RANGANATH KRISHNAN, Hillsboro, OR (US); DEEPAK S. VEMBAR, Portland, OR (US); ROBERT ADAMS, Lake Oswego, OR (US); BRADLEY A. JACKSON, Hillsboro, OR (US)

(73) Assignee: INTEL CORPORATION, Santa Clara, CA (US)

(21) Appl. No.: 15/771,750

(22) PCT Filed: Nov. 2, 2016
(86) PCT No.: PCT/US2016/060093

§ 371 Date: Apr. 27, 2018

Related U.S. Application Data
(60) Provisional application No. 62/250,835, filed on Nov. 4, 2015.

(51) Int. Cl. G06T 17/00; G06T 15/08

(52) U.S. Cl. CPC G06T 17/00; G06T 15/04; G06T 15/08

(57) ABSTRACT

Techniques are provided for 3D model reconstruction of dynamic scenes using hybrid foreground-background processing. A methodology implementing the techniques according to an embodiment includes receiving multiple static images of a scene. Each static image is generated by a static camera, positioned at a fixed location and oriented at a fixed viewing angle. The method also includes receiving multiple dynamic images of the scene, each dynamic image generated by a movable camera. The method further includes performing 3D reconstruction of the scene foreground, based on the static images, and performing 3D reconstruction of the scene background, based on the static images and the dynamic images. The method further includes superimposing the reconstructed 3D foreground and 3D background, with alignment based on calibration parameters (e.g., focal length, principal point, rotation, or translation) of the static and movable cameras, to provide a hybrid 3D reconstruction of the scene for 3D rendering.

### BACKGROUND

Three-dimensional (3D) reconstruction of dynamic scenes from multi-view camera images, for real-time rendering in virtual reality or augmented reality applications, presents a challenging computational problem. Existing solutions are generally limited to viewing relatively small regions of a scene or space, in order to make the problem manageable, or are performed offline (e.g., not in real-time). Some other existing techniques are limited in their ability to fully and realistically capture, in 3D, both the dynamic foreground components of the scene along with the background. For example, some of these techniques may render the background in 2D to reduce the computational burden.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts.

FIG. 1 is a top level diagram of an implementation of a system for hybrid 3D model reconstruction, configured in accordance with certain embodiments of the present disclosure.

FIG. 2 illustrates a 3D scene with static and movable cameras, in accordance with certain embodiments of the present disclosure.

FIG. 3 is a more detailed block diagram of a foreground reconstruction circuit, configured in accordance with certain embodiments of the present disclosure.

FIG. 4 is a more detailed block diagram of a background reconstruction circuit, configured in accordance with certain embodiments of the present disclosure.

FIG. 5 is a flowchart illustrating a methodology for hybrid 3D model reconstruction, in accordance with certain embodiments of the present disclosure.

FIG. 6 is a block diagram schematically illustrating a system platform to perform hybrid 3D model reconstruction, configured in accordance with certain embodiments of the present disclosure.

Although the following Detailed Description will proceed with reference being made to illustrative embodiments, many alternatives, modifications, and variations thereof will be apparent in light of this disclosure.

### DETAILED DESCRIPTION

Generally, this disclosure provides techniques for hybrid foreground-background 3D model reconstruction of dynamic scenes captured with static and movable cameras. The hybrid techniques allow for real-time scene reconstruction with increased visual fidelity by enabling the foreground and background computations to be distributed and executed in parallel across multiple processing resources. The foreground reconstruction is based on volumetric processing techniques, and the background reconstruction is based on feature point or iterative closest point processing techniques. In some embodiments, the volumetric processing may be further sub-divided and distributed among parallel processors to achieve additional efficiencies. While the foreground reconstruction may be performed in real-time, for example updated with each new camera image frame, the background reconstruction can generally be performed less often, such as when the relatively static background of the scene changes. The resulting foreground and background 3D reconstructions are then merged to generate a hybrid reconstruction.

In accordance with an embodiment, the disclosed techniques can be implemented, for example, in a computing system or a graphics processing system, or a software product executable or otherwise controllable by such systems. The system or product is configured to receive multiple static images of a scene. Each static image is generated by a static camera, positioned at a fixed location and oriented at a fixed viewing angle. The system is also configured to receive multiple dynamic images of the scene, each dynamic image generated by a movable camera. The system is further configured to perform 3D reconstruction of the foreground of the scene, based on the static images, and is further configured to perform 3D reconstruction of the background of the scene, based on a combination of the static images and the dynamic images. The term “static images,” as used herein, refers to images generated by the static cameras, which may be pre-calibrated, and the term “dynamic images” refers to images generated by the movable/dynamic cameras. The system is further configured to superimpose the reconstructed 3D foreground and reconstructed 3D background, with alignment based on intrinsic and extrinsic calibration parameters of the static and movable cameras, to provide a hybrid 3D reconstruction of the scene. In some embodiments, the hybrid reconstruction may be used for 3D rendering, for example in a virtual or augmented reality application, or for live (e.g., real-time) transmission of 3D visual data, although other applications will be apparent.

The techniques described herein may allow for improved 3D model fidelity, compared to existing methods that limit viewing regions or render the background in 2D to reduce the computational burden. The disclosed techniques can be implemented on a broad range of computing and communication platforms, including mobile devices, since the techniques are more computationally efficient than existing methods and may offload some computation to cloud based processing resources. These techniques may further be implemented in hardware or software or a combination thereof.

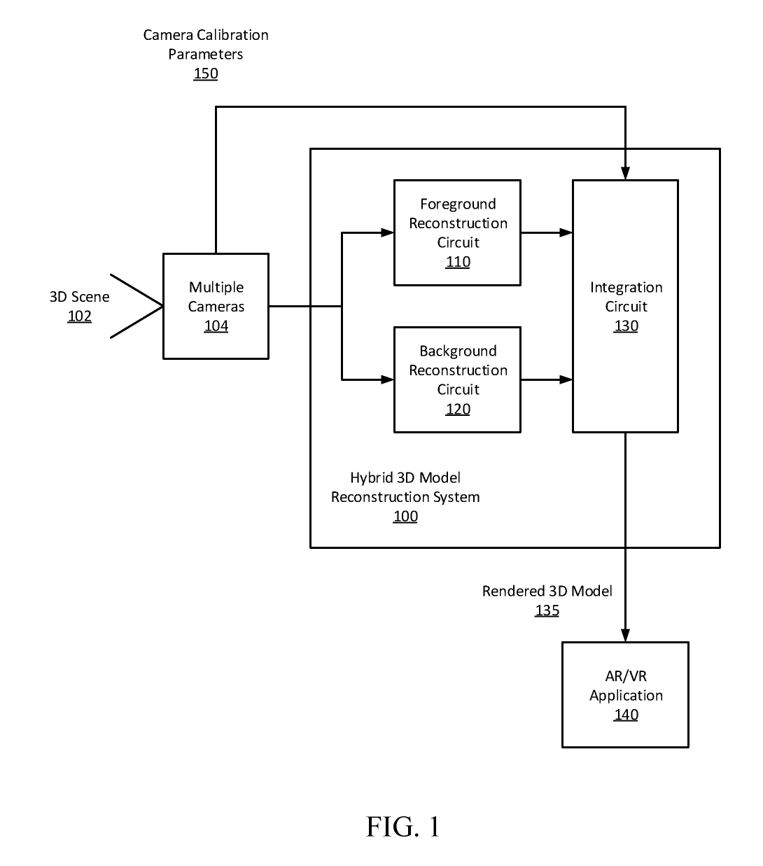

FIG. 1 is a top level diagram of an implementation of a system for hybrid 3D model reconstruction 100, configured in accordance with certain embodiments of the present disclosure. Multiple cameras 104 (including fixed and movable cameras, as explained below) are configured to capture images of an indoor or outdoor 3D scene 102, that may include dynamic features, and provide those images to the hybrid 3D model reconstruction system 100. The hybrid 3D model reconstruction system 100 is configured to generate a reconstructed 3D model 135 of the scene using hybrid foreground-background processing, as will be explained in greater detail below. In some embodiments, the 3D model may be rendered, for example, as a Polygon mesh (PLY), a Wavefront file format (OBJ), or other standard 3D file/object format. In some embodiments, the rendered 3D model 135 may then be provided to a virtual reality (VR) or augmented reality application (AR) 140.

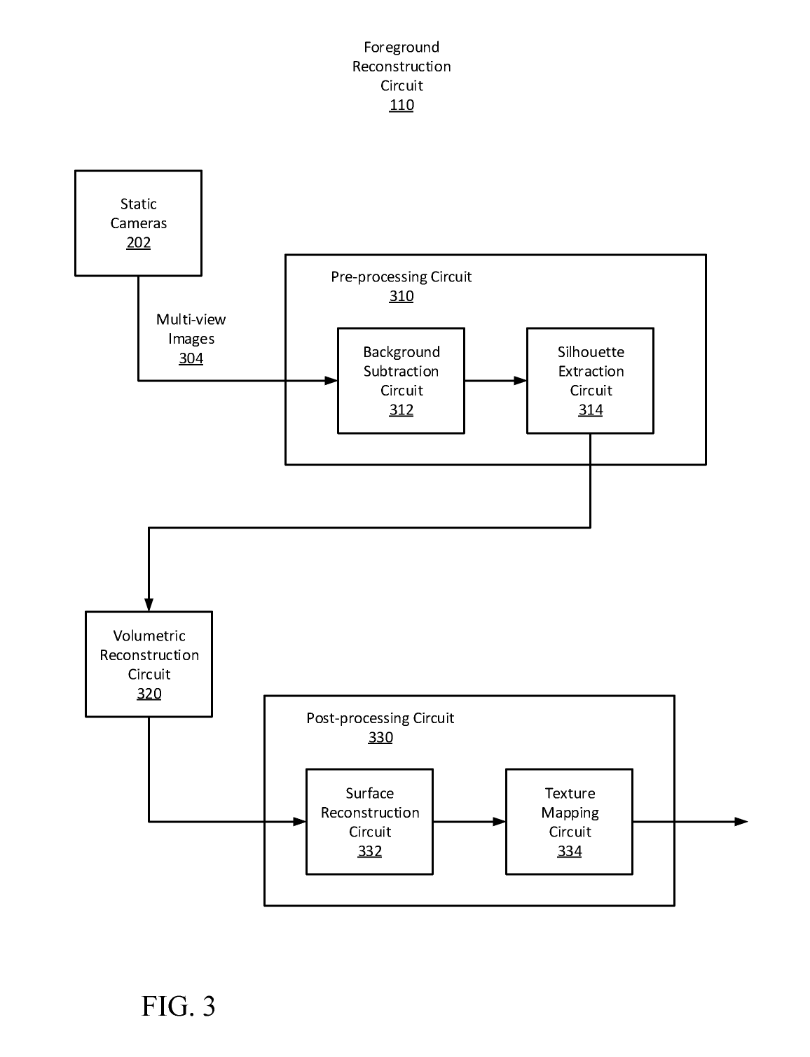

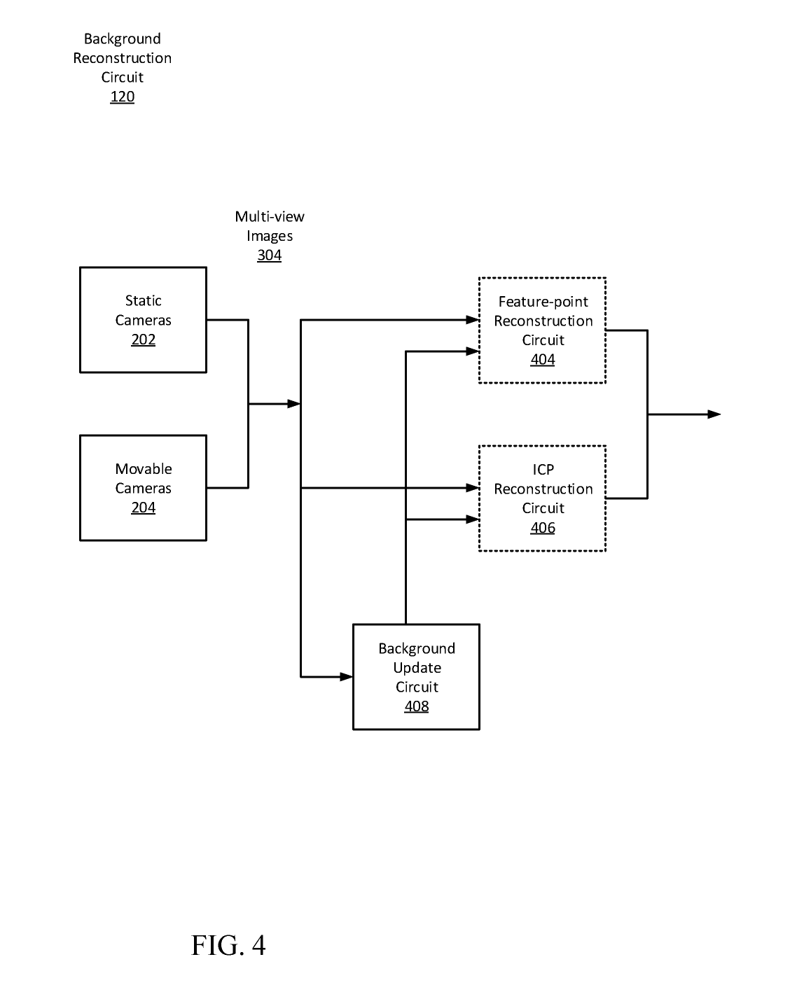

The hybrid 3D model reconstruction system 100 is shown to include a foreground reconstruction circuit 110, a background reconstruction circuit 120, and an integration circuit 130. The foreground reconstruction circuit 110 is configured to perform 3D reconstruction of foreground components of the scene 102 based on volumetric reconstruction applied to multiple static images. The background reconstruction circuit 120 is configured to perform 3D reconstruction of the background of the scene 102 based on feature point reconstruction and/or iterative closest point reconstruction applied to multiple static and dynamic images. The integration circuit 130 is configured to superimpose the reconstructed 3D foreground and 3D background, with alignment based on calibration parameters 150 of the cameras, to provide a hybrid 3D reconstruction of the scene. The operations of the foreground reconstruction circuit 110, background reconstruction circuit 120, and integration circuit 130, will be explained in greater detail below in connection with FIGS. 3 and 4.

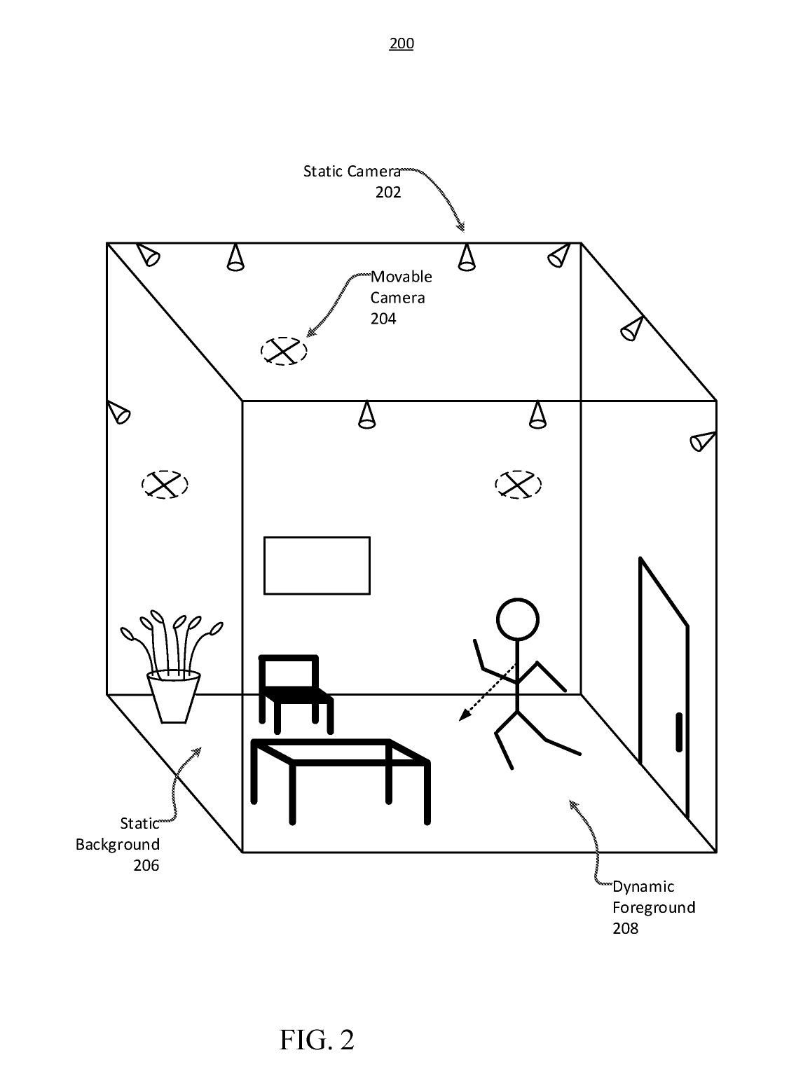

FIG. 2 illustrates a 3D scene 200 with static and movable cameras, in accordance with certain embodiments of the present disclosure. The scene in this example is shown as a room, although that is not required. The scene is composed of a static background 206 which contains static objects, such as a chair, table, and plant. The scene also includes a dynamic foreground 208, which in this example is a moving person. It will be appreciated, however, that static objects may become dynamic when moved, and dynamic objects may become static when at rest. A number of static cameras 202 and movable cameras 204 are deployed to capture images of the foreground and background from multiple viewing angles. The static cameras 202 are located at known, fixed locations and oriented at known fixed viewing angles to capture static images of the scene. The movable cameras 204 may be dynamically moved and oriented throughout the scene to capture dynamic images of the scene from varying perspectives. In some embodiments, the movable cameras may be mounted on drones with remote control capabilities. In some embodiments the movable cameras may include depth information as well as color (e.g., red-green-blue).

FIG. 3 is a more detailed block diagram of a foreground reconstruction circuit 110, configured in accordance with certain embodiments of the present disclosure. The foreground reconstruction circuit 110 is shown to include a pre-processing circuit 310, a volumetric reconstruction circuit 320, and a post-processing circuit 330. The pre-processing circuit 310 comprises a background subtraction circuit 312 and a silhouette extraction circuit 314. The post-processing circuit comprises a surface reconstruction circuit 332 and a texture mapping circuit 334.

The pre-processing circuit 310 is configured to receive multi-view static images 304 (e.g., from different angles), from the static cameras 202 and to perform background subtraction and silhouette extraction with binary segmentation to extract the dynamic foreground components for further foreground processing (e.g., volumetric reconstruction). Background subtraction and silhouette extraction may be performed using known techniques in light of the present disclosure.

The volumetric reconstruction circuit 320 is configured to perform volumetric 3D reconstruction of the pre-processed images, for example, using Shape-from-Silhouette techniques like voxel carving. The voxel carving spatial “divide and conquer” techniques are suitable for vectorization and can therefore be implemented in a distributed and parallel processing manner, for example, over multiple CPUs, GPUs, or cloud based processing resources.

The post-processing circuit 330 is configured to receive the results of volumetric reconstruction and perform surface reconstruction and texture mapping to generate the 3D foreground reconstruction. Surface reconstruction and texture mapping may be performed using known techniques in light of the present disclosure.

In some embodiments, the foreground reconstruction circuit 110 may be configured to perform 3D reconstruction of the foreground in response to receiving each new image frame from the static cameras. Said differently, the foreground reconstruction may be performed in real-time, at the image frame rate of the static cameras, which may be on the order of 30 to 120 frames per second.

FIG. 4 is a more detailed block diagram of a background reconstruction circuit 120, configured in accordance with certain embodiments of the present disclosure. The background reconstruction circuit 120 is shown to include a feature-point reconstruction circuit 404 and/or an iterative closest point (ICP) reconstruction circuit 406, as well as a background update circuit 408.

The feature-point reconstruction circuit 404 is configured to perform 3D background reconstruction using feature-point based techniques such as, for example, Structure-from-Motion, or other suitable techniques in light of the present disclosure. The ICP reconstruction circuit 406 is configured to perform 3D background reconstruction using iterative closest point techniques in light of the present disclosure. Because these techniques generally require a relatively large number of data points, movable cameras 204 are employed to provide sufficient data from multiple adjacent viewpoints. Feature-point reconstruction and ICP reconstruction may be performed using known techniques in light of the present disclosure.

The background update circuit 408 is configured to trigger a new background reconstruction. In some embodiments, the background reconstruction may be updated in response to detecting a change between consecutive frames of the images from the static cameras. That is to say, when temporal changes occur in the images of the background, which exceed a selected change threshold, the 3D reconstruction of the background is refreshed. The threshold may be selected to correspond to a level of change in the scene that results in noticeable effects. In some embodiments, the background reconstruction may be updated on a periodic basis corresponding to a selected background update time interval, for example on the order of one to twenty seconds. In either case, the background reconstruction does not need to be performed at the real-time rate that is used for the foreground reconstruction.

The integration circuit 130 is configured to merge or superimpose the reconstructed 3D foreground and 3D background to provide a hybrid 3D reconstruction of the scene. The merging is accomplished with geometric alignment based on calibration parameters 150 of the static and movable cameras 202 and 204. In some embodiments, the camera calibration parameters 150 may include intrinsic parameters, such as the focal length and the principal point (e.g., the intersection of the optical axis and the image plane) of the cameras. The camera calibration parameters 150 may also include extrinsic parameters, such as the rotation matrix and translation vector of the cameras, which determine the position and viewing angle.

Methodology

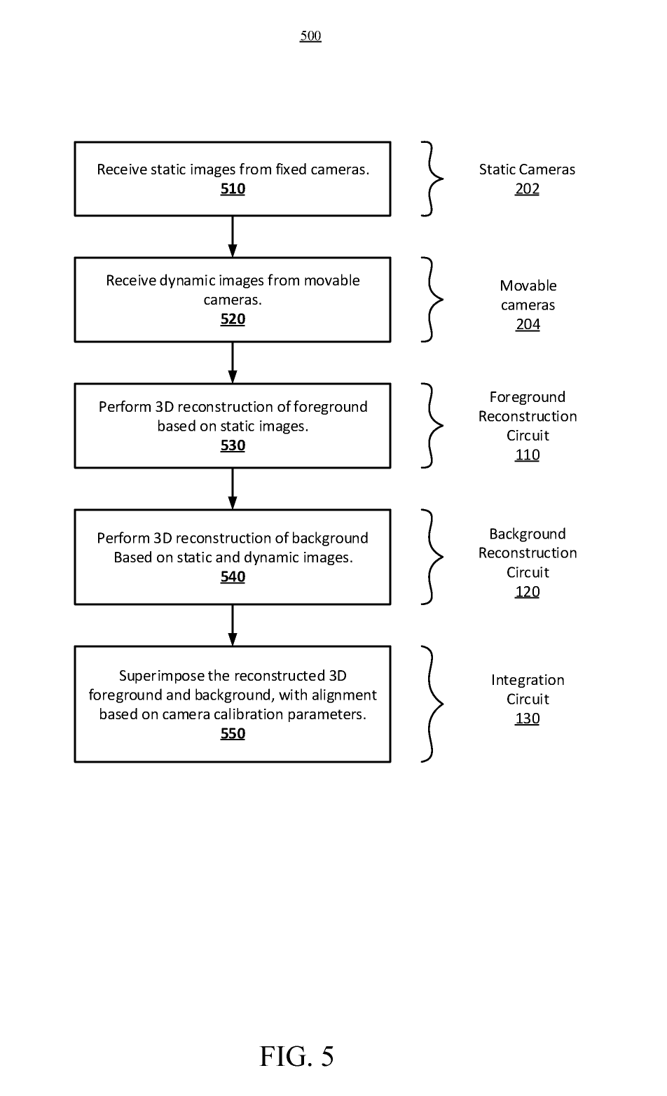

FIG. 5 is a flowchart illustrating an example method 500 for hybrid 3D model reconstruction, in accordance with certain embodiments of the present disclosure. As can be seen, example method 500 includes a number of phases and sub-processes, the sequence of which may vary from one embodiment to another. However, when considered in the aggregate, these phases and sub-processes form a process for hybrid 3D model reconstruction in accordance with certain of the embodiments disclosed herein. These embodiments can be implemented, for example using the system architecture illustrated in FIGS. 3 and 4 as described above. However other system architectures can be used in other embodiments, as will be apparent in light of this disclosure. To this end, the correlation of the various functions shown in FIG. 5 to the specific components illustrated in the other figures is not intended to imply any structural and/or use limitations. Rather, other embodiments may include, for example, varying degrees of integration wherein multiple functionalities are effectively performed by one system. For example, in an alternative embodiment a single module can be used to perform all of the functions of method 500. Thus other embodiments may have fewer or more modules and/or sub-modules depending on the granularity of implementation. In still other embodiments, the methodology depicted can be implemented as a computer program product including one or more non-transitory machine readable mediums that when executed by one or more processors cause the methodology to be carried out. Numerous variations and alternative configurations will be apparent in light of this disclosure.

As illustrated in FIG. 5, in one embodiment, method 500 for hybrid 3D model reconstruction commences by receiving, at operation 510, one or more static images of a scene. The static images are generated by static cameras positioned at fixed, known locations and oriented at fixed viewing angles. At operation 520, one or more dynamic images of the scene are received from movable cameras.

Next, at operation 530, 3D reconstruction of a foreground of the scene is performed, based on the static images. In some embodiments, the 3D reconstruction of the foreground uses volumetric reconstruction based on distributed voxel carving.

At operation 540, 3D reconstruction of a background of the scene is performed, based on the static and dynamic images. In some embodiments, the 3D reconstruction of the background uses feature point reconstruction or iterative closest point reconstruction

At operation 550, the reconstructed 3D foreground and 3D background are superimposed or integrated to provide a hybrid 3D reconstruction of the scene. The integration employs an alignment process that is based on calibration parameters of the static and movable cameras, including focal length, principal point, and rotation matrix and translation vector of the cameras.

Of course, in some embodiments, additional operations may be performed, as previously described in connection with the system. For example, the 3D reconstruction of the foreground may also comprise pre-processing operations that include background subtraction and silhouette extraction. In some embodiments, the 3D reconstruction of the foreground may also comprise post-processing operations that include surface reconstruction and texture mapping.

In some embodiments, the 3D reconstruction of the foreground may be performed in real-time, for example, in response to receiving a new frame of static images. In contrast, the 3D reconstruction of the background may be performed less frequently, for example in response to detecting changes between consecutive frames of the static images, or at selected background update time intervals.

Example System

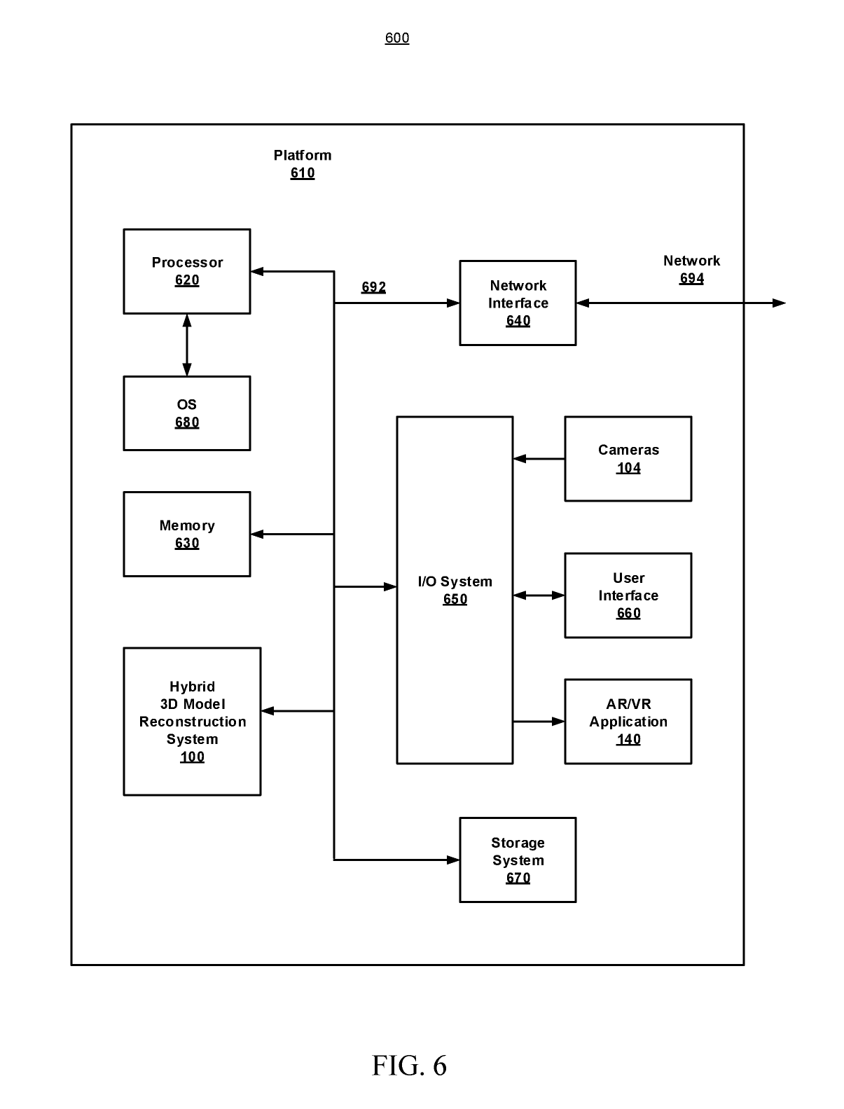

FIG. 6 illustrates an example system 600 to perform light field perception enhancement, configured in accordance with certain embodiments of the present disclosure. In some embodiments, system 600 comprises a platform 610 which may host, or otherwise be incorporated into a personal computer, workstation, laptop computer, ultra-laptop computer, tablet, touchpad, portable computer, handheld computer, palmtop computer, personal digital assistant (PDA), cellular telephone, combination cellular telephone and PDA, smart device (for example, smartphone or smart tablet), mobile internet device (MID), messaging device, data communication device, a television (TV), a smart TV, a TV receiver/converter or set top box, and so forth. Any combination of different devices may be used in certain embodiments.

In some embodiments, platform 610 may comprise any combination of a processor 620, a memory 630, hybrid 3D model reconstruction system 100, a network interface 640, an input/output (I/O) system 650, fixed and movable cameras 104, AR/VR applications 140, a user interface 660 and a storage system 670. As can be further seen, a bus and/or interconnect 692 is also provided to allow for communication between the various components listed above and/or other components not shown. Platform 610 can be coupled to a network 694 through network interface 640 to allow for communications with other computing devices, platforms or resources. Other componentry and functionality not reflected in the block diagram of FIG. 6 will be apparent in light of this disclosure, and it will be appreciated that other embodiments are not limited to any particular hardware configuration.

Processor 620 can be any suitable processor, and may include one or more coprocessors or controllers, such as an audio processor or a graphics processing unit, to assist in control and processing operations associated with system 600. In some embodiments, the processor 620 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core. Processor 620 may be implemented as a complex instruction set computer (CISC) or a reduced instruction set computer (RISC) processor. In some embodiments, processor 620 may be configured as an x86 instruction set compatible processor.

In some embodiments, the disclosed techniques for hybrid 3D model reconstruction can be implemented in a parallel fashion, where tasks may be distributed across multiple CPU/GPU cores or other cloud based resources to enable real-time processing from image capture to display.

Memory 630 can be implemented using any suitable type of digital storage including, for example, flash memory and/or random access memory (RAM). In some embodiments, the memory 630 may include various layers of memory hierarchy and/or memory caches as are known to those of skill in the art. Memory 630 may be implemented as a volatile memory device such as, but not limited to, a RAM, dynamic RAM (DRAM), or static RAM (SRAM) device. Storage system 670 may be implemented as a non-volatile storage device such as, but not limited to, one or more of a hard disk drive (HDD), a solid state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, storage 670 may comprise technology to increase the storage performance enhanced protection for valuable digital media when multiple hard drives are included.

Processor 620 may be configured to execute an Operating System (OS) 680 which may comprise any suitable operating system, such as Google Android (Google Inc., Mountain View, Calif.), Microsoft Windows (Microsoft Corp., Redmond, Wash.), Apple OS X (Apple Inc., Cupertino, Calif.), or Linux. As will be appreciated in light of this disclosure, the techniques provided herein can be implemented without regard to the particular operating system provided in conjunction with system 600, and therefore may also be implemented using any suitable existing or subsequently-developed platform.

Network interface circuit 640 can be any appropriate network chip or chipset which allows for wired and/or wireless connection between other components of computer system 600 and/or network 694, thereby enabling system 600 to communicate with other local and/or remote computing systems, servers, cloud-based servers and/or resources. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 650 may be configured to interface between various I/O devices and other components of computer system 600. I/O devices may include, but not be limited to, cameras 104, AR/VR applications 140, user interface 660, and other devices not shown such as a display element, keyboard, mouse, microphone, and speaker, etc.

I/O system 650 may include a graphics subsystem configured to perform processing of images for rendering on a display element. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 620 or any chipset of platform 610.

It will be appreciated that in some embodiments, the various components of the system 600 may be combined or integrated in a system-on-a-chip (SoC) architecture. In some embodiments, the components may be hardware components, firmware components, software components or any suitable combination of hardware, firmware or software.

Hybrid 3D model reconstruction system 100 is configured to provide 3D model reconstruction of dynamic scenes using hybrid foreground-background techniques. These techniques use volumetric based processing on the scene's dynamic foreground in parallel with feature-point based processing on the scene's background. The foreground and background reconstructions are then merged, with appropriate geometrical alignment, to create a hybrid reconstruction for 3D rendering. Hybrid 3D model reconstruction system 100 may include any or all of the components illustrated in FIGS. 1-5, as described above. Hybrid 3D model reconstruction system 100 can be implemented or otherwise used in conjunction with a variety of suitable software and/or hardware that is coupled to or that otherwise forms a part of platform 610. Hybrid 3D model reconstruction system 100 can additionally or alternatively be implemented or otherwise used in conjunction with user I/O devices that are capable of providing information to, and receiving information and commands from, a user. These I/O devices may include devices collectively referred to as user interface 660. In some embodiments, user interface 660 may include a textual input device such as a keyboard, and a pointer-based input device such as a mouse. Other input/output devices that may be used in other embodiments include a touchscreen, a touchpad, a microphone, and/or a speaker. Still other input/output devices can be used in other embodiments. Further examples of user input may include gesture or motion recognition and facial tracking.

In some embodiments, Hybrid 3D model reconstruction system 100 may be installed local to system 600, as shown in the example embodiment of FIG. 6. Alternatively, system 600 can be implemented in a client-server arrangement wherein at least some functionality associated with these circuits is provided to system 600 using an applet, such as a JavaScript applet, or other downloadable module. Such a remotely accessible module or sub-module can be provisioned in real-time, in response to a request from a client computing system for access to a given server having resources that are of interest to the user of the client computing system. In such embodiments the server can be local to network 694 or remotely coupled to network 694 by one or more other networks and/or communication channels. In some cases access to resources on a given network or computing system may require credentials such as usernames, passwords, and/or compliance with any other suitable security mechanism.

In various embodiments, system 600 may be implemented as a wireless system, a wired system, or a combination of both. When implemented as a wireless system, system 600 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, system 600 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the hybrid 3D model reconstruction methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 694. In other embodiments, the functionalities disclosed herein can be incorporated into other software applications, such as virtual reality applications, gaming applications, entertainment applications, and/or other video processing applications. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus in other embodiments system 600 may comprise additional, fewer, or alternative subcomponents as compared to those included in the example embodiment of FIG. 6.

The aforementioned non-transitory computer readable medium may be any suitable medium for storing digital information, such as a hard drive, a server, a flash memory, and/or random access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CR-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system on-chip (SoC), desktop computers, laptop computers, tablet computers, servers, smart phones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

Further Example Embodiments

The following examples pertain to further embodiments, from which numerous permutations and configurations will be apparent.

Example 1 is a processor-implemented method for 3-dimensional (3D) model reconstruction. The method comprises: receiving a plurality of static images of a scene, each static image generated by a static camera, the static camera positioned at a fixed location and oriented at a fixed viewing angle; receiving a plurality of dynamic images of the scene, each dynamic image generated by a movable camera; performing 3D reconstruction of a foreground of the scene, based on the static images; performing 3D reconstruction of a background of the scene, based on the static images and the dynamic images; and superimposing the reconstructed 3D foreground and 3D background, with alignment based on calibration parameters of the static and movable cameras, to provide a hybrid 3D reconstruction of the scene, the calibration parameters including at least one of focal length of the cameras, principal point of the cameras, rotation matrix of the cameras, and translation vector of the cameras.

Example 2 includes the subject matter of Example 1, wherein the 3D reconstruction of the background further comprises performing one or more of feature point reconstruction and iterative closest point reconstruction.

Example 3 includes the subject matter of Examples 1 or 2, wherein the 3D reconstruction of the foreground further comprises performing volumetric reconstruction based on distributed voxel carving.

Example 4 includes the subject matter of any of Examples 1-3, wherein the 3D reconstruction of the foreground further comprises pre-processing that includes background subtraction and silhouette extraction.

Example 5 includes the subject matter of any of Examples 1-4, wherein the 3D reconstruction of the foreground further comprises post-processing that includes surface reconstruction and texture mapping.

Example 6 includes the subject matter of any of Examples 1-5, further comprising performing the 3D reconstruction of the foreground in response to receiving a new frame of the static images.

Example 7 includes the subject matter of any of Examples 1-6, further comprising performing the 3D reconstruction of the background in response to detecting changes between consecutive frames of the static images.

Example 8 includes the subject matter of any of Examples 1-7, further comprising performing the 3D reconstruction of the background at a selected background update time interval.

Example 9 is a system for 3-dimensional (3D) model reconstruction. The system comprises: a foreground reconstruction circuit to perform 3D reconstruction of a foreground of a scene based on a plurality of static images of the scene, each static image generated by a static camera, each static camera positioned at a fixed location and oriented at a fixed viewing angle; a background reconstruction circuit to perform 3D reconstruction of a background of the scene, based on the static images and further based on a plurality of dynamic images of the scene, each dynamic image generated by a movable camera; and an integration circuit to superimpose the reconstructed 3D foreground and 3D background, with alignment based on calibration parameters of the static and movable cameras, to provide a hybrid 3D reconstruction of the scene, the calibration parameters including at least one of camera focal length, camera principal point, camera rotation matrix, and camera translation vector.

Example 10 includes the subject matter of Example 9, wherein the background reconstruction circuit further comprises one or more of a feature point reconstruction circuit and an iterative closest point reconstruction circuit, to find pairwise point matches between any of the static and dynamic images.

Example 11 includes the subject matter of Examples 9 or 10, wherein the foreground reconstruction circuit further comprises a volumetric reconstruction circuit to perform distributed voxel carving.

Example 12 includes the subject matter of any of Examples 9-11, wherein the foreground reconstruction circuit further comprises a pre-processing circuit to perform background subtraction and silhouette extraction.

Example 13 includes the subject matter of any of Examples 9-12, wherein the foreground reconstruction circuit further comprises a post-processing circuit to perform surface reconstruction and texture mapping.

Example 14 includes the subject matter of any of Examples 9-13, wherein the foreground reconstruction circuit is further to perform the 3D reconstruction of the foreground in response to receiving a new frame of the static images.

Example 15 includes the subject matter of any of Examples 9-14, wherein the background reconstruction circuit is further to perform the 3D reconstruction of the background in response to detecting changes between consecutive frames of the static images.

Example 16 includes the subject matter of any of Examples 9-15, wherein the background reconstruction circuit is further to perform the 3D reconstruction of the background at a selected background update time interval.

Example 17 is at least one non-transitory computer readable storage medium having instructions encoded thereon that, when executed by one or more processors, result in the following operations for 3-dimensional (3D) model reconstruction. The operations comprise: receiving a plurality of static images of a scene, each static image generated by a static camera, each static camera positioned at a fixed location and oriented at a fixed viewing angle; receiving a plurality of dynamic images of the scene, each dynamic image generated by a movable camera; performing 3D reconstruction of a foreground of the scene, based on the static images; performing 3D reconstruction of a background of the scene, based on the static images and the dynamic images; and superimposing the reconstructed 3D foreground and 3D background, with alignment based on calibration parameters of the static and movable cameras, to provide a hybrid 3D reconstruction of the scene, the calibration parameters including at least one of camera focal length, camera principal point, camera rotation matrix, and camera translation vector.

Example 18 includes the subject matter of Example 17, wherein the 3D reconstruction of the background further comprises performing one or more of feature point reconstruction and iterative closest point reconstruction.

Example 19 includes the subject matter of Examples 17 or 18, wherein the 3D reconstruction of the foreground further comprises performing volumetric reconstruction based on distributed voxel carving.

Example 20 includes the subject matter of any of Examples 17-19, wherein the 3D reconstruction of the foreground further comprises pre-processing operations that include background subtraction and silhouette extraction.

Example 21 includes the subject matter of any of Examples 17-20, wherein the 3D reconstruction of the foreground further comprises post-processing operations that include surface reconstruction and texture mapping.

Example 22 includes the subject matter of any of Examples 17-21, the operations further comprising performing the 3D reconstruction of the foreground in response to receiving a new frame of the static images.

Example 23 includes the subject matter of any of Examples 17-22, the operations further comprising performing the 3D reconstruction of the background in response to detecting changes between consecutive frames of the static images.

Example 24 includes the subject matter of any of Examples 17-23, the operations further comprising performing the 3D reconstruction of the background at a selected background update time interval.

Example 25 is a system for 3-dimensional (3D) model reconstruction. The system comprises: means for receiving a plurality of static images of a scene, each static image generated by a static camera, the static camera positioned at a fixed location and oriented at a fixed viewing angle; means for receiving a plurality of dynamic images of the scene, each dynamic image generated by a movable camera; means for performing 3D reconstruction of a foreground of the scene, based on the static images; means for performing 3D reconstruction of a background of the scene, based on the static images and the dynamic images; and means for superimposing the reconstructed 3D foreground and 3D background, with alignment based on calibration parameters of the static and movable cameras, to provide a hybrid 3D reconstruction of the scene, the calibration parameters including at least one of focal length of the cameras, principal point of the cameras, rotation matrix of the cameras, and translation vector of the cameras.

Example 26 includes the subject matter of Example 25, wherein the 3D reconstruction of the background further comprises means for performing one or more of feature point reconstruction and iterative closest point reconstruction.

Example 27 includes the subject matter of Examples 25 or 26, wherein the 3D reconstruction of the foreground further comprises means for performing volumetric reconstruction based on distributed voxel carving.

Example 28 includes the subject matter of any of Examples 25-27, wherein the 3D reconstruction of the foreground further comprises means for pre-processing that includes background subtraction and silhouette extraction.

Example 29 includes the subject matter of any of Examples 25-28, wherein the 3D reconstruction of the foreground further comprises means for post-processing that includes surface reconstruction and texture mapping.

Example 30 includes the subject matter of any of Examples 25-29, further comprising means for performing the 3D reconstruction of the foreground in response to receiving a new frame of the static images.

Example 31 includes the subject matter of any of Examples 25-30, further comprising means for performing the 3D reconstruction of the background in response to detecting changes between consecutive frames of the static images.

Example 32 includes the subject matter of any of Examples 25-31, further comprising means for performing the 3D reconstruction of the background at a selected background update time interval.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not be this detailed description, but rather by the claims appended hereto. Future filed applications claiming priority to this application may claim the disclosed subject matter in a different manner, and may generally include any set of one or more elements as variously disclosed or otherwise demonstrated herein.

1. A processor-implemented method for 3-dimensional (3D) model reconstruction, the method comprising:
receiving, by a processor-based system, a plurality of static images of a scene, each static image generated by a static camera, the static camera positioned at a fixed location and oriented at a fixed viewing angle;
receiving, by the processor-based system, a plurality of dynamic images of the scene, each dynamic image generated by a movable camera;
performing, by the processor-based system, 3D reconstruction of a foreground of the scene, based on the static images;
performing, by the processor-based system, 3D reconstruction of a background of the scene, based on the static images and the dynamic images; and
superimposing, by the processor-based system, the reconstructed 3D foreground and 3D background, with alignment based on calibration parameters of the static and movable cameras, to provide a hybrid 3D reconstruction of the scene, the calibration parameters including at least one of focal length of the cameras, principal point of the cameras, rotation matrix of the cameras, and translation vector of the cameras.

2. The method of claim 1, wherein the 3D reconstruction of the background comprises performing one or more of feature point reconstruction and iterative closest point reconstruction.

3. The method of claim 1, wherein the 3D reconstruction of the foreground comprises at least one of:
performing volumetric reconstruction based on distributed voxel carving;
pre-processing that includes background subtraction and silhouette extraction; and
post-processing that includes surface reconstruction and texture mapping.

4. (canceled)

5. (canceled)

6. The method of claim 1, wherein the 3D reconstruction of the foreground is performed in response to receiving a new frame of the static images.

7. The method of claim 1, wherein the 3D reconstruction of the background is performed in response to detecting changes between consecutive frames of the static images.

8. The method of claim 1, wherein the 3D reconstruction of the background is performed at a selected background update time interval.

9. A system for 3-dimensional (3D) model reconstruction, the system comprising:
a foreground reconstruction circuit to perform 3D reconstruction of a foreground of a scene based on a plurality of static images of the scene, each static image generated by a static camera, each static camera positioned at a fixed location and oriented at a fixed viewing angle;
a background reconstruction circuit to perform 3D reconstruction of a background of the scene, based on the static images and further based on a plurality of dynamic images of the scene, each dynamic image generated by a movable camera; and
an integration circuit to superimpose the reconstructed 3D foreground and 3D background, with alignment based on calibration parameters of the static and movable cameras, to provide a hybrid 3D reconstruction of the scene, the calibration parameters including at least one of camera focal length, camera principal point, camera rotation matrix, and camera translation vector.

10. The system of claim 9, wherein the background reconstruction circuit comprises one or more of a feature point reconstruction circuit and an iterative closest point reconstruction circuit, to find pairwise point matches between any of the static and dynamic images.

11. The system of claim 9, wherein the foreground reconstruction circuit comprises at least one of:
a volumetric reconstruction circuit to perform distributed voxel carving;
a pre-processing circuit to perform background subtraction and silhouette extraction; and
a post-processing circuit to perform surface reconstruction and texture mapping.

12. (canceled)

13. (canceled)

14. The system of claim 9, wherein the foreground reconstruction circuit is further to perform the 3D reconstruction of the foreground in response to receiving a new frame of the static images.

15. The system of claim 9, wherein the background reconstruction circuit is further to perform the 3D reconstruction of the background in response to detecting changes between consecutive frames of the static images.

16. The system of claim 9, wherein the background reconstruction circuit is further to perform the 3D reconstruction of the background at a selected background update time interval.

17. At least one non-transitory computer readable storage medium having instructions encoded thereon that, when executed by one or more processors, result in the following operations for 3-dimensional (3D) model reconstruction, the operations comprising:
receiving a plurality of static images of a scene, each static image generated by a static camera, each static camera positioned at a fixed location and oriented at a fixed viewing angle;
receiving a plurality of dynamic images of the scene, each dynamic image generated by a movable camera;
performing 3D reconstruction of a foreground of the scene, based on the static images;
performing 3D reconstruction of a background of the scene, based on the static images and the dynamic images; and
superimposing the reconstructed 3D foreground and 3D background, with alignment based on calibration parameters of the static and movable cameras, to provide a hybrid 3D reconstruction of the scene, the calibration parameters including at least one of camera focal length, camera principal point, camera rotation matrix, and camera translation vector.

18. The computer readable storage medium of claim 17, wherein the 3D reconstruction of the background comprises performing one or more of feature point reconstruction and iterative closest point reconstruction.

19. The computer readable storage medium of claim 17, wherein the 3D reconstruction of the foreground comprises performing volumetric reconstruction based on distributed voxel carving.

20. The computer readable storage medium of claim 17, wherein the 3D reconstruction of the foreground comprises pre-processing operations that include background subtraction and silhouette extraction.

21. The computer readable storage medium of claim 17, wherein the 3D reconstruction of the foreground comprises post-processing operations that include surface reconstruction and texture mapping.

22. The computer readable storage medium of claim 17, the operations further comprising performing the 3D reconstruction of the foreground in response to receiving a new frame of the static images.

23. The computer readable storage medium of claim 17, the operations further comprising performing the 3D reconstruction of the background in response to detecting changes between consecutive frames of the static images.

24. The computer readable storage medium of claim 17, the operations further comprising performing the 3D reconstruction of the background at a selected background update time interval.
